(19) United States
(12) Patent Application Publication
(10) Pub. No.: US 2013/0067093 A1
(43) Pub. Date: Mar. 14, 2013

(54) Determining Essential Resources in a Wireless Network

(71) Applicants: Salvador Pedraza Moreno, Malaga (ES); Juan Ramiro Moreno, Malaga (ES)

(72) Inventors: Salvador Pedraza Moreno, Malaga (ES); Juan Ramiro Moreno, Malaga (ES)

(73) Assignee: Optimi Corporation, Atlanta, GA (US)

(21) Appl. No.: 13/634,647

(22) PCT Filed: Mar. 16, 2011
(86) PCT No.: PCT/US11/28652

§ 371 Date: Nov. 26, 2012

Related U.S. Application Data
(60) Provisional application No. 61/314,252, filed on Mar. 16, 2010.

(51) Int. Cl. H04W 72/04

(52) U.S. Cl. 709/226

(57) ABSTRACT

Concepts and technologies are disclosed herein for identifying a network resource in a wireless networking environment as essential. A network resource to be tested is identified. The network resource is transitioned to a softbar operation state. In the softbar operation state, use of the network resource is avoided. If access data indicates substantial use of the network resource, the network resource can be identified as essential.

### CROSS REFERENCE TO RELATED APPLICATION

This application claims priority to U.S. Provisional Patent Application Ser. No. 61/314,252, entitled “Determining Essential Resources for Energy Management in a Wireless Network,” filed Mar. 16, 2010, which is hereby incorporated by reference in its entirety.

### TECHNICAL FIELD

The present disclosure relates generally to wireless networks. More particularly, the present disclosure relates to determining essential resources in a wireless network.

### BACKGROUND

A goal of mobile and wireless communication system operators is to provide adequate service to customers at a minimum cost. Operating costs of networking equipment can constitute a substantial portion of operating costs associated with a network. The operating costs can include maintenance costs, hardware and software updates for the equipment, and power, bandwidth, and other network resource consumption associated with the equipment.

Because equipment is rarely added to a network without sufficient demand to justify the capital expenditure, network operators often are restricted from considering eliminating equipment totally from the network. Thus, network operators may consider various approaches to reduce costs associated with operating the equipment such as upgrading the equipment to more reliable and/or energy efficient equipment, and/or deactivating the equipment at certain times.

Costs associated with the equipment may be managed by temporarily deactivating the equipment. Determining what network resources may be temporarily deactivated requires extensive data analysis. Furthermore, the risks associated with temporarily deactivating the equipment can be substantial, so the analysis must be correct to avoid negatively affecting network operations.

It is with respect to these and other considerations that the disclosure made herein is presented.

### SUMMARY

Concepts and technologies are described herein for determining if network resources in a wireless network are essential or non-essential. In accordance with the concepts and technologies disclosed herein, network resources associated with a wireless networking environment can be identified as being essential network resources or non-essential network resources. Network resources identified as being non-essential may be switched to a low-power or off state to conserve energy during periods of reduced usage. A network resource determined to be essential, may be determined not to be a candidate for being switched to a low power or off state.

According to one embodiment disclosed herein, a method identifying a network resource in a wireless networking environment as essential includes identifying a network resource to be tested and transitioning the network resource to a softbar operation state. Use of a network resource in a softbar operation state may be avoided. It is determined if access data indicates usage of the network resource. If the access data indicates substantial usage of the network resource, the network resource is identified as being essential based upon the determination that the access data indicates usage of the network resource

as to whether the attempt to use the network resource is an attempt to use the network resource as a last resort.

In some embodiments, the softbar state further includes an operation state in which use of the network resource is allowed for an attempt to use the network resource as a last resort. The method also can include determining a time period during which the network resource is to be operated in the softbar state, determining if the time period has expired, and obtaining the access data in response to determining that the time period has expired. The method also can include identifying the network resource as non-essential by determining that access data does not indicate substantial use of the network resource. In some embodiments, the access data includes data identifying usage of the network resource during the time period. The method also can include taking an action to reduce the power consumption of the network resource, in response to identifying the network resource as non-essential. According to another embodiment, a method for identifying a network resource in a wireless networking environment as essential includes identifying, at a central controller, a network resource to be tested. A time period during which the network resource is to be tested is defined. The method also includes generating a command for transitioning the network resource to a softbar operation state. In the softbar state, use of the network resource can be avoided. The method also includes determining if the time period has expired, and in response to determining that the time period has expired, obtaining access data describing activity associated with the network resource during the time period, and identifying the network resource as an essential network resource in response to determining that the access data indicates substantial usage of the network resource during the time period.

In some embodiments, the method further includes generating a command for transitioning the network resource out of a softbar operation state, in response to determining that the time period has expired. The method also can include identifying the network resource as a non-essential network resource in response to determining that the access data does not indicate substantial usage of the network resource during the time period. The method further can include maintaining the network resource in the softbar operation state, in response to determining that the time period has not expired.

In some embodiments, the network resource includes a base station of the wireless networking environment, and determining that the access data does not indicate usage of the network resource during the time period includes determining that the time period has expired without an attempted handover of a communication to the base station. The method also can include receiving the access data from the base station, the access data including data indicating activity associated with the base station during the time period. The method further can include receiving access data including data indicating activity associated with the network resource during the time period.

According to another embodiment, a central controller is configured to identify a network resource as essential. The central controller includes a central processing unit in communication with a mass storage device. Execution of computer-executable instructions stored in the mass storage device cause the central processing unit to identify a network resource to be tested, to define a time period during which the network resource is to be tested, and to generate a command for transitioning the network resource to a softbar operation state. In the softbar operation state, use of the network resource can be avoided. Execution of the computer-executable instructions can further cause the central processing unit to determine if the time period has expired and, in response to determining that the time period has expired, obtain access data describing activity associated with the network resource during the time period, and identify the network resource as a non-essential network resource in response to determining that the access data indicates substantial usage of the network resource during the time period.

In some embodiments, execution of the computer-executable instructions stored in the mass storage device further cause the central processing unit to generate a command for transitioning the network resource out of a softbar operation state, in response to determining that the time period has expired. Execution of the computer-executable instructions stored in the mass storage device also can cause the central processing unit to identify the network resource from two or more network resources, and the two or more network resources provide services to a geographic area.

In some embodiments, the two or more network resources include two or more base stations, each of the two or more base stations has a respective coverage area, and at least two of the coverage areas of the base stations overlap, at least partially. Usage of the network resource can include a handover of a call from one of the two or more base stations to a second of the two or more base stations, and the call can be associated with a mobile station located within at least one of the two or more coverage areas. Usage of the network resource can include access of the base station as a last resort during the time period.

According to another embodiment, a central controller is configured to identify a base station as essential. The central controller includes a central processing unit in communication with a mass storage device. Execution of computer-executable instructions stored in the mass storage device cause the central processing unit to identify a base station to be tested and transition the base station to a softbar operation state. Use of the base station can be avoided during operation of the base station in the softbar operation state. Execution of the computer-executable instructions stored in the mass storage device further can cause the central processing unit to detect an attempt to use the base station during operation in the softbar state, determine if the attempt to use the base station includes an attempt to use the base station as a last resort, identify the base station as essential in response to determining that the attempt to use the base station includes an attempt to use the base station as a last resort, identify the base station as non-essential in response to determining that there is no substantial usage of base station as last resort, and reduce power consumption associated with the base station, in response to identifying the base station as non-essential.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a wireless networking environment according to one or more embodiments presented herein;

FIG. 2 is a line diagram illustrating additional aspects of the concepts and technologies disclosed herein;

FIG. 3 is a logical flow diagram illustrating a process for determining essential resources in a wireless network, according to some embodiments presented herein;

FIG. 4 is a logical flow diagram illustrating another process for determining essential resources in a wireless network, according to some embodiments presented herein;

FIG. 5 is a logical flow diagram illustrating yet another process for determining essential resources in a wireless network, according to some embodiments presented herein; and

FIG. 6 is a computer architecture diagram illustrating computing system hardware capable of determining essential resources in a wireless network, according to some embodiments presented herein.

### DETAILED DESCRIPTION

The following description is directed to concepts and technologies for determining essential resources in a wireless network (“network resources”). According to some implementations of the concepts and technologies disclosed herein, network resources associated with a wireless network may be identified as being “essential” or “non-essential.” The word essential, as used herein, does not mean “necessary,” “indispensable,” and/or other terms implying the same meaning. As used herein, an essential network resource is a network resource that may be useful or helpful to a wireless network operator for the purposes of maintaining quality of service (QoS) of communications, preventing premature and/or unintended termination of voice and/or data communications, providing user services that are expected or needed at a particular time, and/or for other purposes. Thus, an essential network resource may not be necessary to maintaining service in a network, but may be helpful, useful, or needed to maintain an acceptable service level or to provide certain services or communications in the network.

Similarly, a network resource may be identified as being non-essential to a network if the network resource is not be helpful, useful, or needed at a particular time to maintain service in the network, to maintain an acceptable service level, and/or to provide certain services or communications in the network at a particular time. Thus, a non-essential network resource is network resource that is not useful or needed at a particular time to maintain QoS of communications, to prevent premature or unintended termination of voice and/or data communications, to provide services, and/or other purposes.

According to some embodiments of the concepts and technologies disclosed herein, network resources that are identified as being non-essential can be switched into operation states in which usage of various network, bandwidth, power, maintenance, and/or other resources are reduced, minimized, and/or eliminated. For example, a non-essential network resource may be operated in a low-power or off state to help conserve energy or other resources. In some embodiments, a particular network resource may be determined to be non-essential during one or more time periods of anticipated reduced network resource usage, and thus can be switched to the operation states mentioned above for reducing network, bandwidth, power, maintenance, and/or other resources.

According to various implementations, a central controller is configured to test network resources to determine if the network resources are essential or non-essential. The central controller may test the network resources using a “softbar state.” As will be explained in more detail herein, when a network resource operates in a “softbar” state, of the network resource is avoided and/or restricted unless usage of the network resource is attempted as a last resort, or in a last resort condition. A last resort condition is a situation in which failure to use the network resource operating in the softbar state is expected to result in an adverse occurrence such as, for example, a reduction in QoS, a “dropped call” or other form of premature or unintended termination of a voice or data communication, injury or death in a case of an emergency, a failure to provide services or communications, and the like. Thus, according to various embodiments disclosed herein, a network resource operating in a softbar state may be forced into use if a last resort condition is detected by the central controller or the network resource operating in the softbar state.

Thus, the softbar state can be readily distinguished from a bar or barred operation state. A network resource operating in a barred state can be restricted from providing any services, even in last resort conditions. While operating network resources in a barred state can be useful in testing network operations, such testing can have adverse consequences on communication quality and/or an ability to provide services or communications for customers. Thus, various embodiments of the concepts and technologies disclosed herein make use of a softbar state to test network resources without risking the adverse consequences described herein.

In accordance with implementations of the concepts and technologies disclosed herein, network resources are operated in a softbar state during a test period. The test period can be defined by a network operator or other authorized entity, testing software, historical usage information associated with the tested network resource, and/or other considerations. After the test period ends, or during the test period if desired, network usage information and/or other access data can be obtained or received. The access data can be analyzed or reviewed to determine if the network resource being tested in the softbar state was used or accessed during the test period. In some embodiments, any usage of the network resource is considered, and in other embodiments, substantial usage of the network resource is considered, wherein substantial usage that lasts a particular amount of time or uses a particular percentage or threshold amount of network resource capacity. The amount of time and/or percentage or threshold amount can be set by preferences, based upon current operating information, and/or other considerations. If the network resource was used during the test period, and if such usage is substantial, the data suggests that the network resource was needed in a last resort condition during the test period. As such, the network resource may be treated, tagged, or labeled as an essential network resource.

Similarly, if the network resource was not used during the test period, or was used but not in a substantial manner, the data can suggest that the network resource was not needed in a last resort condition during the test period. As such, the network resource may be treated, tagged, or labeled as a non-essential network resource. As mentioned above network resources that are identified as being non-essential may be commanded to switch to a low-power or off state to conserve energy, and/or otherwise modify their operation to conserve power, bandwidth, and/or network resources. These and other aspects of the concepts and technologies disclosed herein will be discussed in more detail below.

While the subject matter described herein is presented in the general context of program modules that execute in conjunction with the execution of an operating system and application programs on a computer system or embedded processor system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of computing systems and methodologies for determining essential resources in a wireless network are described.

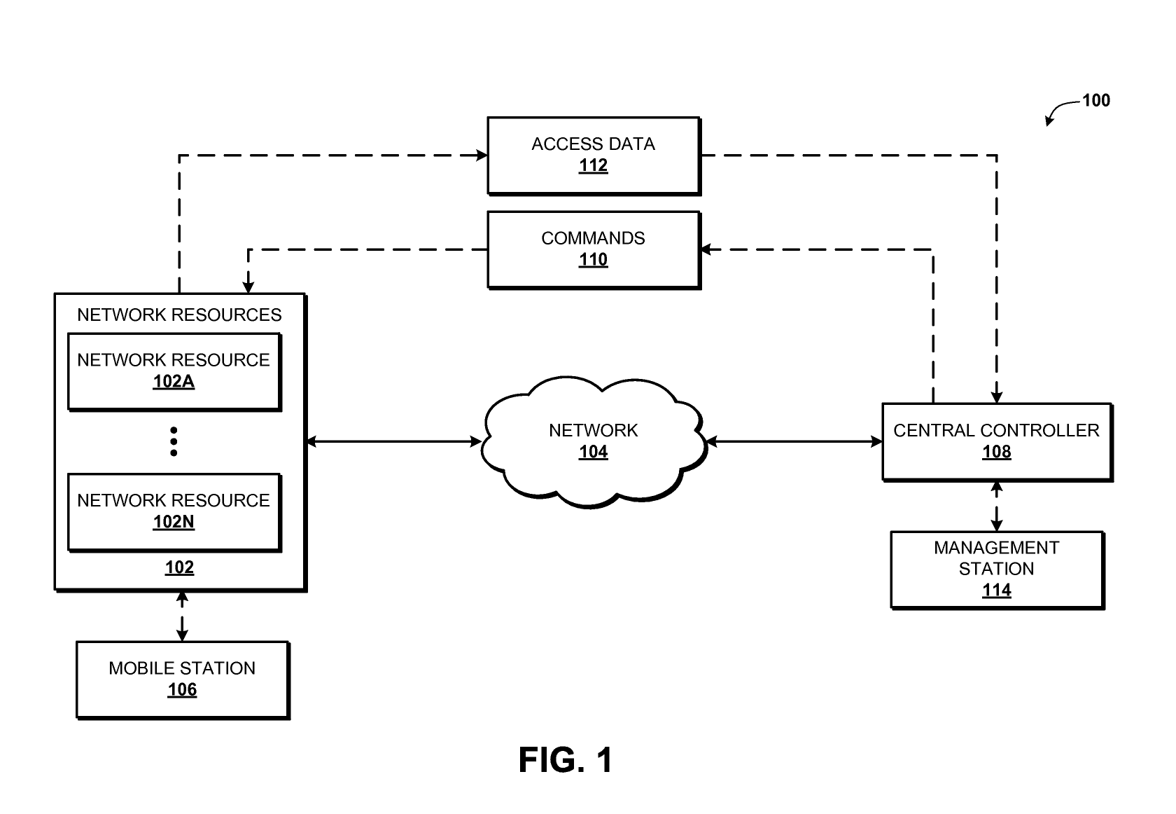

Turning now to FIG. 1, a block diagram illustrating a wireless networking environment 100 is provided, according to various embodiments of the concepts and technologies presented herein. In the illustrated embodiment, the wireless networking environment 100 includes one or more network resources 102A-102N, hereinafter referred to collectively as “network resources 102” or generically as a “network resource 102.” The network resources 102 are configured to communicate with various networks, systems, and/or components within or via a network 104. The network 104 can include any combination of wireless and wired networks, including packet-based and/or circuit switched networks.

The network resources 102 include computing, hardware, software, networking, and/or other resources used to provide services to one or more users, network nodes, devices, and/or other systems or networks within or in communication with the wireless networking environment 100. For example, the network resources 102 can include cellular communications equipment for communicating with a mobile station 106 operating on or in communication with the wireless networking environment 100. According to various implementations, the network resources 102 include various network components. For example, the network resources 102 can include, but are not limited to, antennas, antenna components, radios, receivers, transceivers, GPRS core network components, location service nodes, an Internet Protocol Multimedia Subsystem (IMS), other systems and/or components, and the like. The network resources 102 also can include base transceiver stations (BTSs), Node-Bs or e-Node-Bs, base station controllers (BSCs), mobile management entities (MMEs), radio network controllers (RNCs), mobile switching centers (MSCs), multimedia messaging service centers (MMSCs), short message service centers (SMSCs), home location registers (HLRs), home subscriber servers (HSSs), visitor location registers (VLRs), charging and/or billing platforms, voicemail platforms, combinations thereof, and the like. The network resources 102 also can include other network components, systems, and/or other resources, and therefore should not be construed as being limited to cellular communication hardware and/or software.

According to various implementations, the mobile station 106 includes, but is not limited to, a wireless cellular telephone, a smart phone, a laptop computer, a tablet computer, a desktop computer, a set-top box (STB), a personal data assistant (PDA), a global positioning system (GPS) receiver, an automobile communication system, combinations thereof, and the like. For purposes of simplifying description of the concepts and technologies disclosed herein, the mobile station 106 is described herein as a cellular communications device such as a feature phone or a smart phone. It should be understood that this embodiment is illustrative, and should not be construed as being limiting in any way.

The network resources 102 can communicate with and/or be monitored or controlled by a central controller 108 operating on or in communication with the network 104. The central controller 108 is configured to execute an operating system and one or more application programs for providing the functionality described herein for determining essential resources in a wireless network. The operating system is a computer program for controlling the operation of the central controller 108. Examples of operating systems include, but are not limited to, a member of the MAC OS, iOS, and/or LEOPARD OS families of operating systems from the Apple Corporation in Cupertino, Calif., a member of the WINDOWS, WINDOWS MOBILE, and/or WINDOWS SERVER families of operating systems from Microsoft Corporation in Redmond, Wash., a member of the LINUX family of operating systems, a member of the SYMBIAN family of operating systems, a member of the BREW family of operating systems from Qualcomm Corporation in San Diego, Calif., a member of the FREEBSD family of operating systems, combinations thereof, and the like.

The application programs executed by the central controller 108 can include one or more executable programs that are configured for execution on top of the operating system to provide the functionality described herein for determining essential resources in a wireless network. While the central controller 108 is described herein as executing the application programs to provide the functionality described herein, it should be understood that this embodiment is illustrative. More particularly, in some embodiments, the application programs are embodied in or as one or more hardware devices separate from the central controller 108. Thus, the illustrated embodiment should be understood as being illustrative of one contemplated embodiment, and should not be construed as being limiting in any way.

The central controller 108 is configured to test one or more of the network resources 102 to determine which, if any, of the network resources 102 are essential or non-essential. More particularly, the central controller 108 determines network resources 102 to test, determines time periods for the testing, issues one or more commands 110 to the network resources 102 for executing the tests, and receives access data 112 from the network resources 102 or a monitoring or reporting platform, analyzes or reviews the access data 112, and determines if access of the network resources 102 occurred during the test period. As mentioned above, only substantial uses of the network resources 102 may be considered in some embodiments. Thus, for example, pings, operation information reporting, status indicators, and/or other non-substantial usage of the network resources 102 may be ignored, in some embodiments.

The commands 110 are interpretable by the network resources 102 to change an operating state of the network resources to a softbar state, as described herein. The commands 110 also can specify a time period defined for operation in the softbar state and, therefore, the time period during which the testing will last. In response to receiving the commands 110, the network resources 102 can switch an operating state of the network resources 102 to a softbar state for testing whether the network resource 102 is essential or non-essential.

According to various embodiments, the time period for testing the network resources 102 is defined by the central controller 108 or other sources. In some embodiments, for example, a user interfaces with the central controller 108 via a management station 114. The user can define one or more time periods via the management station 114, if desired. Similarly, the central controller 108 can define the time periods based on network usage models, monitored traffic information, set preferences and/or configuration files, combinations thereof, and the like.

The time period can be as long or as short as desired, depending upon needs or preferences associated with the testing. For example, the central controller 108 can define a relatively short time period such as a number of seconds, minutes, and/or hours for testing if the network resource is essential or non-essential. Similarly, the central controller 108 can define a relatively long time period such as one or more hours or days for testing if the network resource 102 is essential or non-essential. In one non-limiting example, a particular network resource 102 may be tested over a weekend or a holiday to determine if the network resource 102 is essential over the weekend or the holiday. Similarly, the network resources 102 may be tested over a number of seconds, minutes, or hours to determine if the network resource is essential or non-essential during the number of seconds, minutes, or hours. It should be understood that these embodiments are illustrative, and should not be construed as being limiting in any way.

The central controller 108 generates and transmits the commands 110 to the network resources 102. The network resources 102 enter the softbar state in response to the commands 110 and monitor access attempts during the defined test periods. In some embodiments, the network resources 102 self-report the access data 112 to the central controller 108, and in some embodiments, the network resources 102 are monitored by external systems, hardware, or software (not shown in FIG. 1) for the access data 112. The access data 112 can define how the network resources 102 are accessed and/or how access to the network resources 102 is requested or attempted when the network resources 102 are or were operating in the softbar state. The network resources 102 also can be configured to execute a test application (not shown) for self-reporting the access data 112 to the central controller 108, if desired.

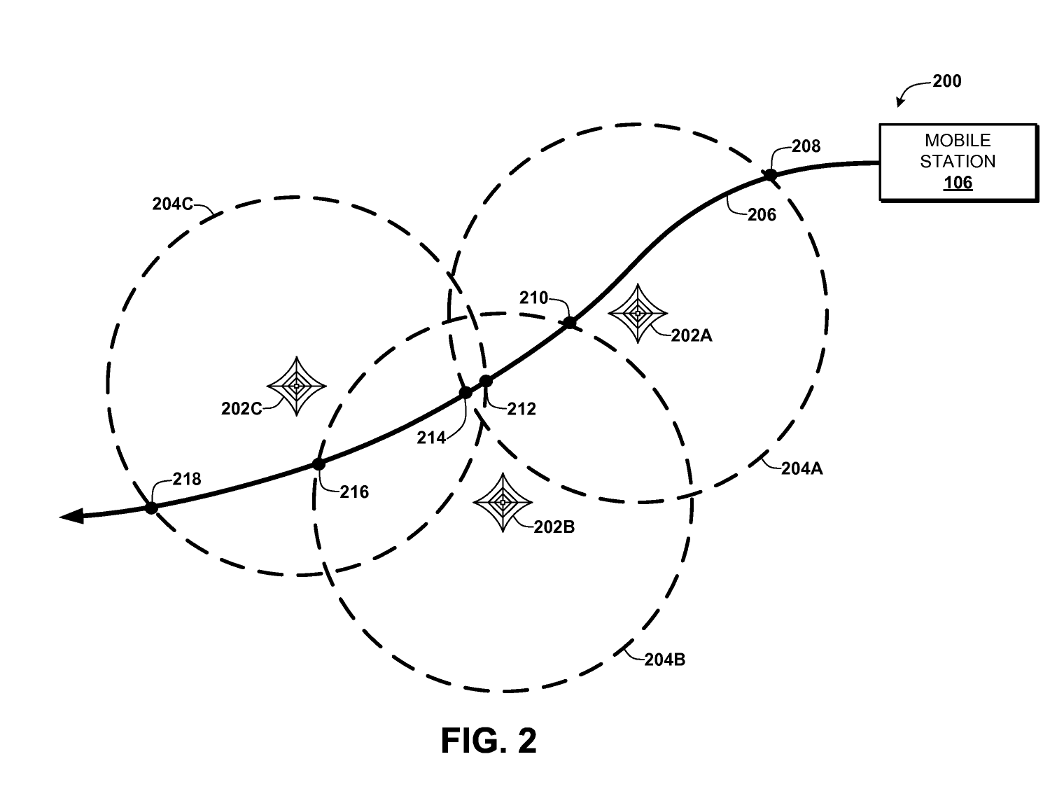

The access data 112 identifies access requests associated with the network resources 102 and/or access of the network resources 102. The access data 112 can identify a number of times the network resource 102 was accessed or access is attempted during the test period, and what types of access have occurred or been attempted. Because the network resource 102 is tested by switching the network resource 102 into a softbar operation state, the access data 112 indicates, by indicating traffic and/or usage associated with the network resource 102, if the access or access attempts detected during the test occurred during a last resort condition as defined herein. In other words, the access data 112 indicates, by virtue of indicating usage of the network resource 102 during operation in a softbar operation state, that the access or access attempts occurred during a last resort condition. As mentioned above, the usage of the network resource 102 may be ignored if the usage is not substantial. In some embodiments, substantial usage is any usage used to service customer requests or communications, and non-substantial usage is any usage relating to network operations and/or non-value-added services. This embodiment is exemplary, as usage satisfying threshold percentages, amounts, times, and the like, also can be considered as being substantial. Thus, based upon the access data 112, the central controller 108 can identify the tested network resources 102 as being essential or non-essential. These and other aspects of the concepts and technologies disclosed herein are described in additional detail with reference to FIGS. 2-5 below.

FIG. 1 illustrates multiple network resources 102, one mobile station 106, and one central controller 108. It should be understood, however, that some implementations of the wireless networking environment 100 include one or more network resources 102, multiple mobile stations 106, and/or multiple central controllers 108. Therefore, the illustrated embodiment should be understood as being illustrative, and should not be construed as being limiting in any way.

Turning now to FIG. 2, additional aspects of the concepts and technologies disclosed herein for determining essential resources in a wireless network are described in detail. In particular, FIG. 2 illustrates a line diagram showing an example scenario in which the concepts and technologies disclosed herein may be implemented. It should be understood that the embodiment illustrated in FIG. 2 is illustrative of only one contemplated scenario and should not be construed as being limiting in any way.

In FIG. 2, three base stations 202A-C (hereinafter collectively referred to as “base stations 202”) are illustrated. The base stations 202 can include one or more antennas, antenna positioning systems, radio frequency components, amplifiers, transceivers, relay modules, power supplies, and various other subsystems and components associated with mobile communication base station systems. Thus, the base stations 202 can be or can include one or more of the network resources 102 described above with reference to FIG. 1.

Three coverage areas 204A-C (hereinafter collectively referred to as “coverage areas 204”) are illustrated in FIG. 2. The coverage areas 204A-C correspond, respectively, to coverage areas of the base stations 202A-C. In particular, the coverage area 204A is associated with the base station 202A, the coverage area 204B is associated with the base station 202B, and the coverage area 204C is associated with the base station 202C. As shown in FIG. 2, the coverage areas 204 may or may not overlap partially and/or completely. It should be understood that the illustrated base stations 202, coverage areas 204, and their respective overlaps are illustrative, and should not be construed as being limiting in any way.

In the scenario illustrated in FIG. 2, the mobile station 106 moves through or adjacent to the coverage areas 204 along a path 206. According to one example, the path 206 corresponds to a road, highway, waterway, walkway, or other path along which the mobile station 106 travels. For purposes of illustrating the concepts and technologies disclosed herein, the path 206 can be considered as corresponding to a highway upon which a user in possession of the mobile station 106 travels. It should be understood that this embodiment is illustrative, and should not be construed as being limiting in any way. As the mobile station 106 moves along the path 206, the mobile station 106 can pass into and out of the coverage areas 204. Furthermore, as the mobile station 106 moves along the path 206, the mobile station may be within more than one coverage area 204 at a particular time.

More particularly, as the mobile station 106 moves along the path 206, the mobile station 106 enters the coverage area 204A at a first point 208. At a second point 210, the mobile station 106 enters the coverage area 204B. It can be appreciated from FIG. 2 that the mobile station can simultaneously be within the coverage area 204A and the coverage area 204B after encountering the second point 210 while moving along the path 206. The mobile station 106 will remain within the coverage areas 204A, 204B until the mobile station 106 encounters the third point 212.

Upon encountering the third point 212, the mobile station 106 can be within all three coverage areas 204. The mobile station 106 remains within all three coverage areas 204 until the mobile station 106 encounters a fourth point 214, at which the mobile station 106 leaves the coverage area 204A. Upon encountering a fifth point 216, the mobile station 106 exits the coverage area 204B, after which the mobile station 106 is only within the coverage area 204C. The mobile station 106 exits the coverage area 204C at the sixth point 218. Although not illustrated in FIG. 2, it should be understood that additional and/or alternative coverage areas 204 may exist adjacent to the illustrated coverage areas 204. Furthermore, it should be appreciated that the coverage areas 204 can vary in size and shape based upon hardware associated with the base stations 202, power output of the mobile station 106, geographic topography and/or natural or manmade structures within the coverage areas 204, other factors, and the like.

From the scenario illustrated in FIG. 2, it can be appreciated that the mobile station 106 traveling along the path 106 may operate within the wireless networking environment 100. At any particular time, one of the three base stations 204 may handle calls, data communications, and/or other traffic associated with the mobile station 106. For purposes of simplifying the description of the concepts and technologies disclosed herein, the communications will be referred to as a “call.” It should be understood that this embodiment is illustrative, and should not be construed as being limiting in any way. As described above, the call may first be serviced by the base station 204A. As the mobile station 106 travels along the path 206, the call may be passed, or handed off, to one or more of the base station 204B and the base station 204C.

According to various implementations of the concepts and technologies disclosure herein, the central controller 108 is configured to test one or more of the base stations 202 to determine if the base stations 202 are essential or non-essential to providing service to the mobile station 106 and/or other devices within the coverage areas 204. With respect to the illustrated scenario, the central controller 108 is configured to test the base stations 202 to determine if each of the base stations 202 is essential or non-essential to servicing the call associated with the mobile station 106 during a particular time, for example, as the mobile station 106 travels along the path 206.

In some embodiments, the central controller 108 commands one or more of the base stations 202 to transition to a softbar state as described herein. As explained above, network resources such as the network resources 102 and/or the base stations 202, while in the softbar state, may be barred from use unless the network resources 102 and/or the base stations 202 are needed as a last resort. For example, as the mobile station 106 travels along the path 206, the base station 202A servicing a call between the first point 208 and the fourth point 214, may attempt handover of the call to the base station 202B at the fourth point 214. If the base station 202B is in a softbar state, however, the base station 202B may refuse the handoff from the base station 202A. As such, the base station 202A may instead attempt to handover the call to the base station 202C.

If the handover to the base station 202C satisfies call servicing requirements for the call, and therefore is successful, then the central controller 108 can determine that the base station 202B can remain in the softbar state. Similarly, the central controller 108 can identify the base station 202B as a candidate for being treated, tagged, or labeled as being non-essential, as the call was successfully handed over from the base station 202A to the base station 202C without use of the base station 202B. It should be understood that this embodiment is illustrative, and should not be construed as being limiting in any way.

According to some embodiments of the concepts and technologies disclosed herein, the base stations 202 and/or other network resources 102 that are identified as being non-essential can be configured to run in a low-power or off state. Network resources 102 and/or the base stations 202 running in a low-power or off state may conserve less power, bandwidth, network, maintenance, and/or other resources relative to network resources 102 and/or base stations 202 running in a standard or default on state. In particular, network resources 102 and/or base stations 202 operating in a low-power or off state can reduce power consumption of the wireless networking environment 100. Thus, some embodiments of the concepts and technologies disclosed herein provide methods and systems for providing power management of network resources such as the network resources 102 and/or the base stations 202.

In the above-illustrated scenario of FIG. 2, however, if the base station 202C cannot accept handover of the call from the base station 202A at the fourth point 214, then the base station 202B may be required to accept handover of the call to prevent dropping of the call or other premature and/or unintended termination of the call. In such a scenario, the base station 202B may be considered essential for servicing calls. As such, the central controller 108 can determine that the base station 202B may not be a good candidate to switch to a low-power or off state. It therefore can be appreciated that in addition to providing systems and methods for providing power management of network resources, the concepts and technologies disclosed herein also can provide intelligent network resource utilization, and can help avoid deactivating, putting into a low-power state, and/or powering down network resources that are essential, as defined herein, to proper network operation.

The softbar state referred to herein should not be confused with a barred state. In a barred state, network resources such as the network resources 102 and/or the base stations 202 may be prohibited from participating in any communications, even in cases in which a last resort condition exists. A network resource such as the network resource 102 and/or the base stations 202 placed into the softbar state, however, will be prohibited from participating in any communications unless a last resort condition arises, as explained above. In the case of a voice call, for example, a handover from the base station 202A to the base station 202B may fail if the second base station 202B is operating in a barred state, while the same or a similar handover may succeed if the base station 202B instead is operating in a softbar state. It should be understood that this embodiment is illustrative, and should not be construed as being limiting in any way.

Furthermore, according to various embodiments of the concepts and technologies disclosed herein, softbar testing can be conducted on network resources 102 in an idle mode and/or a connection mode. In particular, a wireless cell or other resource 102 may be placed into an idle mode for softbar testing. As such, the wireless cell may be given a low priority for use, wherein the wireless cell services calls or other communications for devices such as the mobile station 106 that are unable to get coverage from other wireless cells.

The wireless cell may also be placed into a connection mode for softbar testing. In the connection mode, handovers to the wireless cell being tested are disabled when the handover is attempted by another wireless cell that is capable of providing acceptable service. Thus, in the connection mode only last resort handovers are accepted by the tested wireless cell. As mentioned above, a last resort condition may be defined as a situation where a low service level or a poor service quality is being provided by other wireless cells and handover is indicated as being necessary to preventing termination of the communication or unacceptable degradation of call quality or one or more other QoS measures.

According to various implementations, the central controller 108, the management station 114, and/or other devices and/or systems can use topology information of the wireless cell under softbar test along with wireless cells neighboring the tested wireless cell to analyze the wireless networking environment 100. The topology information and/or other information can be used to generate parameterization for placing the test wireless cell into the softbar state. Topology information may include the nature of interfaces and interactions between a wireless cell and other wireless cells within the network, as well as other information. Furthermore, a wireless cell, or other network resource 102, may be put into a softbar state for a period of time for the testing. As mentioned above, the period of time can include a number of seconds, minutes, hours, days, weeks, and the like. If the network resource 102 being tested is not used during the defined time period, the network resource 102 may be decommissioned. According to other embodiments, a wireless cell, or other network resource 102 may be placed into a softbar state for a period of time such as a night. If the network resource 102 is not used during the defined period of time, the network resource 102 may be switched to a low-power or off state for energy management during the next time period similar or identical to the test period such as the next night. It should be understood that this embodiment is illustrative, and should not be construed as being limiting in any way.

In addition to placing one or more specific wireless cells into a softbar operation state, other granularities or types of network resources 102 may be identified for softbar testing. For example, as explained above, base stations 202 may be put into the softbar state. Similarly, various levels within a hierarchy of network resources 102 can be simultaneously tested. For example, a wireless cell may remain operational while frequency bands or specific services may be switched into a softbar state to test if the frequency bands or specific services are essential or non-essential.

The concepts and technologies presented herein may be used to simplify and improve radio frequency propagation estimation techniques for wireless network analysis. The radio frequency propagation estimation techniques may be used with network planning tools to estimate the propagation of communication signals within the wireless networking environment 100. Radio frequency propagation estimates may provide an indication of an expected impact for removing from operation a network resource such as the network resources 102 and/or the base stations 202, from use in the wireless networking environment 100.

The radio frequency propagation estimates can involve complex calculations on large amounts of information. For example, the radio frequency propagation estimates can involve information defining various physical and operational characteristics for various network resources such as the network resources 102 and/or the base stations 202. The information can include, for example, latitude, longitude, azimuth, antenna type, propagation models, calibration corrections, terrain maps, traffic maps, power requirements, power output, output frequencies, ambient temperature information, failure rates, other information, combinations thereof, and the like.

Generally, information used in calculating radio frequency propagation estimates must be extremely accurate to obtain precise and usable results. Imprecise and/or erroneous information may result in radio frequency propagation estimates that incorrectly suggest that a network resource such as the network resources 102 and/or the base stations 202 may be removed from service, switched to a low-power or off state, and/or otherwise removed or restricted from normal usage. If a network resource such as the network resources 102 and/or the base stations 202 is removed from service due to imprecise or erroneous information, adverse and/or unexpected results may be experienced within the wireless networking environment 100, as mentioned above.

Using the concepts and technologies presented herein, the identification of non-essential network resources 102 may be performed with reduced complexity and/or reduced reliance upon the information sometimes used in generating radio frequency propagation estimates. Thus, identification of non-essential network resources 102 can be simplified by using the concepts and technologies disclosed herein. Additionally and/or alternatively, the risks associated with imprecise and/or erroneous information, as well as calculations based thereon, can be reduced by employing various embodiments of the concepts and technologies disclosed herein.

Furthermore, results of an analysis for identifying essential and/or non-essential network resources 102 as disclosed herein may be verified in operation before actions based upon the analysis are implemented. In some embodiments, the results are verified in operation by placing network resources such as the network resources 102 and/or the base stations 202 expected to be non-essential network resources 102 into the softbar state. If the classification of the network resource 102 as non-essential is erroneous, the network resource 102 may, during operation in the softbar state, be transitioned out of the softbar state, and continue to function as a part of the wireless networking environment 100. If the network resource 102 remains in the softbar state for a specified duration, for example a test period, the central controller 108 may verify the non-essential status of the tested network resource 102, and take various actions in response to this verification.

It should be appreciated that while the classification of a network resource 102 as being essential or non-essential is discussed herein as being a binary outcome, the concepts and technologies disclosed herein are not so limited. In particular, in some embodiments, results from testing a network resource 102 using the softbar state analysis disclosed herein can produce a classification of the network resource 102 as being less than completely essential and/or less than completely non-essential. For example, the concepts and technologies discussed herein may be used to determine a percentage, probability, likelihood score, or some other scale of outcome for classifying a network resource 102 as essential or non-essential. A percentage, probability, or scaled score may indicate how likely a network resource 102 is to remain essential or non-essential, or to become essential or non-essential based upon traffic levels, failure rates, geographic topology, network topology, time of day, and/or other operating characteristics of the wireless networking environment 100 or the location associated with the network resource 102.

The concepts and technologies disclosed herein can be used in conjunction with various wireless communication network technologies in various combinations. For example, the concepts and technologies disclosed herein may be applied to mobile communication wireless cells, wireless network operating zones, various granularities of operation within those or other resources, combinations thereof, and the like. Furthermore, a service or frequency band may be specified as the network resource 102 to test and/or to identify as being essential or non-essential. Thus, the service or frequency band may be operated in the softbar state and monitored to determine if the service or frequency is essential or non-essential.

Furthermore, the concepts and technologies disclosed herein may be applied to various mobile technologies operating in accordance with various standards and/or protocols including, but not limited to, second generation (2G) Global System for Mobile communications (GSM), General Packet Radio Service (GPRS) and/or Enhanced Data rates for GSM Evolution (EDGE) standards, third generation (3G) technologies, 3G Universal Mobile Telecommunications System (UMTS), High-Speed Packet Access (HSPA), e.g., the High-Speed Downlink Packet Access (HSDPA), Enhanced Uplink (EUL)/High-Speed Uplink Packet Access (HSUPA), and/or the Evolved HSPA (HSPA+), fourth generation (4G) and pre-4G technologies such as, for example, Long Term Evolution (LTE) technologies, Worldwide Interoperability for Microwave Access (WiMAX) technologies, and the like. The concepts and technologies disclosed herein also can be employed in networks using Code Division Multiple Access (CDMA) technologies, wideband CDMA (WCDMA) technologies, time division multiple access (TDMA) technologies, any other wireless communication network standards, protocols, or technology, combinations thereof, and the like. While the wireless networking environment 100 is described as including a cellular communications network, it should be understood that the concepts and technologies disclosed herein can also be used in non-cellular wireless networks such as WIFI networks, BLUETOOTH communications, and the like.

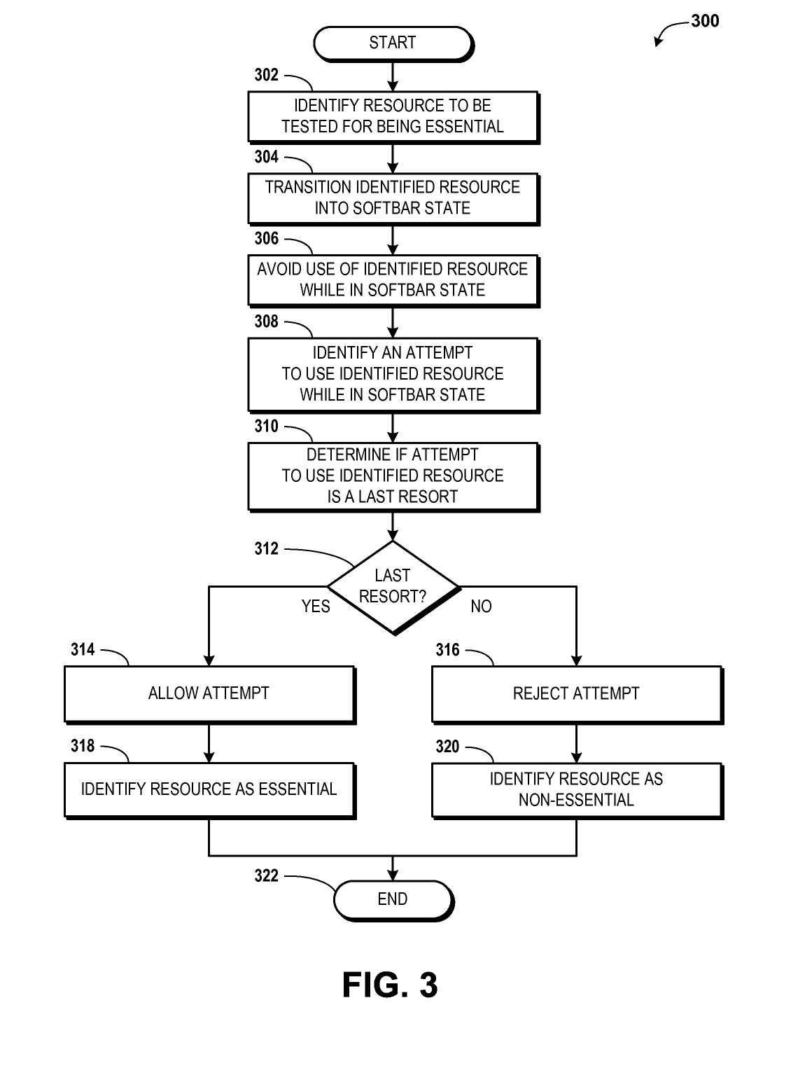

Turning now to FIG. 3, aspects of a method 300 for determining essential resources in a wireless network will be described in detail, according to some embodiments presented herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the methods disclosed herein can be ended at any time and need not be performed in its entirety. Some or all operations of the methods, and/or substantially equivalent operations, can be performed by execution of computer-readable instructions included on a computer-storage media, as defined above. The term “computer-readable instructions,” and variants thereof, as used in the description and claims, is used expansively hereinto include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent upon the performance and/or other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts and technologies disclosed herein, the methods are described as being performed by the central controller 108. It should be understood that the central controller 108, as well as additional and/or alternative devices and/or network nodes, can provide the functionality described herein via execution of one or more application programs. Furthermore, it should be understood that the functionality of the central controller 108 can be provided by any number of devices or network nodes, and is not limited to the central controller 108 illustrated in the FIGURES. Thus, the illustrated embodiment is illustrative, and should not be viewed as being limiting in any way.

The method 300 begins with operation 302 where a network resource 102 may be identified to undergo testing to determine if the network resource 102 is an essential network resource 102 or a non-essential network resource 102. The network resource 102 identified for testing may be identified explicitly by an operator or other authorized entity, or the network resource 102 may be selected through a simulation or test plan. For example, the network resource 102 can be identified as a likely candidate for power reduction, and the test can be conducted to determine if the network resource 102 is essential or non-essential, thereby determining if the network resource 102 can be switched to a low-power or off state. A network resource 102 can be tested as being essential or non-essential, and if the network resource 102 is identified as being non-essential, the network resource 102 may be powered down for time periods during which the network resource 102 is non-essential, as defined herein. Powering down a network resource 102 can provide various benefits such as reduced energy consumption associated with the network resource 102 and/or the wireless networking environment 100, improved life expectancy of the network resource 102, reduced network operating or maintenance costs and complexity, combinations thereof, and the like.

From operation 302, the method 300 proceeds to operation 304. At operation 304, the network resource 102 identified in operation 302 may be transitioned into a softbar state. From operation 304, the method 300 proceeds to operation 306. At operation 306, use of the network resource 102 identified in operation 302 may be avoided. For example, if the network resource 102 identified in operation 302 corresponds to a base station 202, a handover to the base station 202 can be avoided unless the handover corresponds to a last resort condition as defined herein. Thus, as illustrated in FIG. 3, use of the identified network resource 102 may be avoided while the network resource 102 is in the softbar state.

From operation 306, the method 300 proceeds to operation 308. At operation 308, an attempt to use the identified network resource 102 while the network resource 102 is operating in a softbar state can be identified. The attempt to use the network resource 102 may be identified explicitly from a request to access a certain service or network resource 102. Additionally, or alternatively, the attempt to use the network resource 102 may be recognized via a handover offering from a wireless cell or other communications network resource that neighbors or communicates with the network resource 102 being tested.

From operation 308, the method 300 proceeds to operation 310. At operation 310, it may be determined if the attempt recognized in operation 308 corresponds to an attempt to use the identified network resource 102 as a last resort. If the call or data access associated with the attempt recognized in operation 308 may fail without use of the network resource 102, then the attempt may be considered to be a last resort attempt.

From operation 310, the method 300 proceeds to operation 312. At operation 312, the method 300 may continue to operation 314 if it was determined at operation 310 that the attempt recognized in operation 308 corresponds to an attempt to access the identified network resource 102 as a last resort. Alternatively, from operation 312, the method 300 may continue to operation 316 if it was determined at operation 310 that the attempt recognized in operation 308 did not correspond to an attempt to access the identified network resource 102 as a last resort.

At operation 314 the attempt recognized in operation 308 may be allowed because the attempt to access the network resource 102 corresponds to an attempt as a last resort. From operation 314, the method 300 proceeds to operation 318. At operation 318, the network resource 102 can be identified as an essential network resource 102, because use of the network resource 102 was determined to be required as a last resort.

At operation 316, the attempt recognized in operation 308 may be rejected because the attempt to access the network resource 102 does not correspond to an attempt as a last resort. From operation 316, the method 300 proceeds to operation 320. At operation 320, the network resource 102 may remain in a softbar state. The network resource 102 may also be identified as a non-essential network resource 102 since the network resource 102 was not accessed as a last resort.

From operations 318 and 320, the method 300 proceeds to operation 322. The method 300 terminates at operation 322. Although not depicted in FIG. 3, the method 300 may also be repeated periodically or continuously.

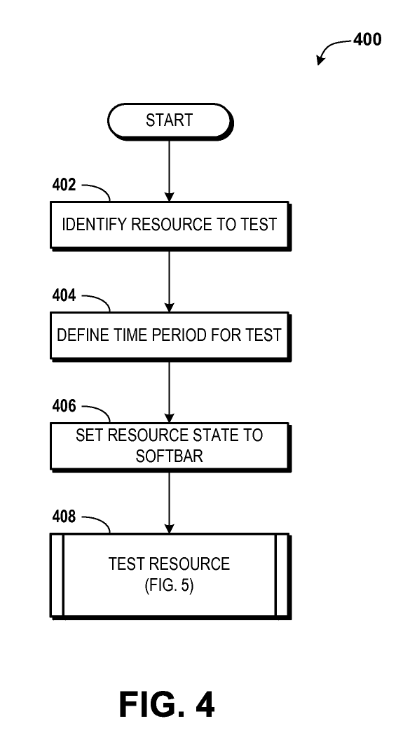

Turning now to FIG. 4, a method 400 for determining essential resources in a wireless network is illustrated, according to some embodiments disclosed herein. The method 400 begins at operation 402, wherein the central controller 108 identifies a network resource 102 to test. More particularly, the central controller 108 identifies a network resource 102 to test in a softbar operation state to determine if the network resource 102 is an essential network resource or a non-essential network resource. The network resource 102 can be selected according to various considerations, as discussed above with reference to operation 302 of FIG. 3. Thus, for example, a network operator or other authorized entity, a software program, and/or other users, software, systems, and/or devices can select the network resource 102 for testing based upon time schedules, rotating test schedules, network performance data, other considerations, and the like. Furthermore, the network resource 102 can be selected randomly for testing, and/or the network resource 102 can be manually specified for testing, if desired.

From operation 402, the method 400 proceeds to operation 404, wherein the central controller 108 specifies a time period for the test. As explained herein, the test can include switching the network resource 102 into a softbar state for a period of time, and determining if the network resource 102 is needed during that period of time as a network resource 102 of last resort. Thus, the operation 402 includes defining the length or duration of the test. According to various implementations, the time period ranges from one or more portions of a second to one or more seconds, minutes, hours, days, and/or weeks. Thus, it should be understood that the time period can be set to almost any time period, depending upon various considerations such as network traffic, special events in the geographic vicinity of the network resources 102, operational information associated with neighboring network resources 102, historical network usage information, road construction or obstructions, other considerations, combinations thereof, and the like.

From operation 404, the method 400 proceeds to operation 406, wherein the central controller 108 sets an operating state of the network resource 102 to the softbar state. As explained above, the central controller 108 can issue one or more commands 112 and transmit the commands 112 to the network resources 102. The network resources 102 are configured to switch to the softbar state in response to receiving the commands 112. Upon receiving the commands 112, the network resources 102 can switch to the softbar state and/or schedule a switch to the softbar state for testing at another time.

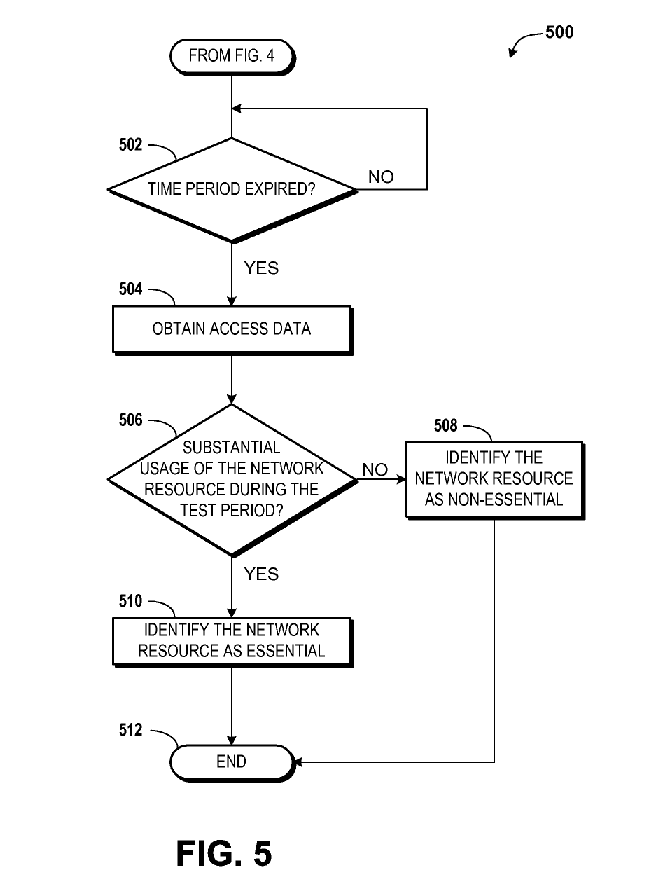

From operation 406, the method 400 proceeds to operation 408, wherein the network resource 102 is tested. The test process can include the functionality discussed above with reference to FIGS. 1-3 and/or the functionality discussed below with reference to FIG. 5. In the illustrated embodiment, the method 400 ends at operation 408, and a test process such as the process illustrated in FIG. 5 is executed.

Turning now to FIG. 5, a method 500 for determining essential resources in a wireless network is described in detail, according to some embodiments presented herein. The method 500 begins at operation 502, which can be reached via execution of the operations discussed above with reference to FIG. 4. In operation 502, the central controller 108 determines if the time period determined in operation 404 has expired. If the central controller 108 determines in operation 502 that the time period has not expired, the method 500 can pause at or return to operation 502, and the central controller 108 can again determine if the time period has expired. If the central controller 108 determines in operation 502 that the time period has expired, the method 500 proceeds to operation 504.

In operation 504, the central controller 108 obtains access data 112 and/or other network usage data that describes traffic and/or resource usage during the time period. As explained herein, the access data 112 can be obtained from one or more monitoring and/or reporting systems or platforms including, but not limited to, a monitoring server, the network resources 102, and/or other systems, devices, and/or nodes.

From operation 504, the method 500 proceeds to operation 506, wherein the central controller 108 analyzes the access data 112 and/or other network usage information to determine if any substantial usage of the network resource 102 occurred during the time period, also referred to herein as the test period. If the central controller 108 determines, in operation 506, that substantial usage of the network resource 102 did not occur during the time period, the method 500 proceeds to operation 508. It should be understood from the description herein, that in some embodiments, any usage of the network resource 102 is considered substantial. Thus, the illustrated embodiment should be understood as being illustrative, and should not be construed as being limiting in any way.

At operation 508, the central controller 108 can identify the tested network resource 102 as a non-essential network resource 102. According to various implementations, network resources 102 identified as being non-essential may be treated, tagged, or labeled as being non-essential, and other actions can be taken with respect to the resources 102 as explained herein. If the central controller 108 determines, in operation 506, that substantial usage of the network resource 102 did not occur during the time period, the method 500 proceeds to operation 510. As noted above, the central controller 108 can determine that any usage of the network resource 102 is or is not substantial based upon various considerations, preferences, operating conditions, combinations thereof, and the like.

At operation 510, the central controller 108 tags or labels the network resource 102 as an essential network resource. Thus, the network resource 102 tested may be determined not to be a suitable candidate for operation in a low-power or off state, since the network resource 102 was used and/or used in a substantial manner, during the time period. Substantial usage of the network resource 102 during the time period can be understood by the central controller 108 as indicating that the network resource 102 was forced to exit the softbar operation state during the time period of the test to service an access request in a last resort condition. As should be appreciated in light of the description herein, the central controller 108 can determine the network resource 102 is essential or non-essential based upon the access data 112 or other monitoring information or data received by the central controller 108. The network resource 102 also can label itself as being essential or non-essential, via execution of one or more application programs executing on the network resource 102.

From operation 510, or from operation 506, the method 500 proceeds to operation 512. The method 500 ends at operation 512. Although not illustrated in FIG. 5, it should be understood that the central controller 108 can return execution to the beginning of FIG. 4, wherein the central controller 108 can identify the same or another resource 102 for testing. Additionally, as disclosed herein, the central controller 108 can take various actions based upon the determination that the network resource 102 is essential or non-essential including, but not limited to, switching or commanding a switch of the network resource 102 to a low-power or off state, indicating that the network resource 102 can or should be decommissioned, indicating that the network resource 102 can or should be relocated or reallocated, and/or other actions.

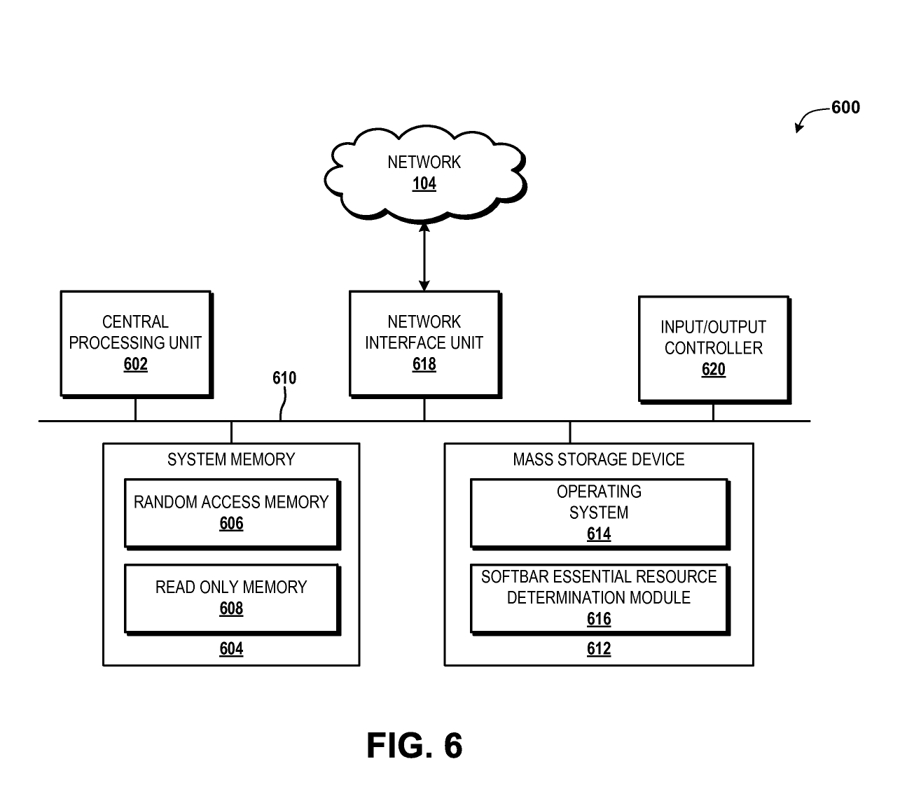

Turning now to FIG. 6, an illustrative computer architecture 600 for a computing device capable of executing software components described herein for determining essential resources in a wireless network will be described. The computer architecture 600 shown in FIG. 6 illustrates an embedded control computer, a desktop computer, a laptop computer, a server computer, a cellular telephone, a smart phone, a PDA, combinations thereof, and the like, and can be configured to execute aspects of the software components presented herein. For example, a device having an architecture similar to the computer architecture 600 of FIG. 6 may serve as the central controller 108, the management station 110, the mobile station 106, and/or a controller, base station controller, or other device associated with one or more of the base stations 202. It should be appreciated that the described software components can also be executed on other example computing environments, such as game consoles, television displays, STBs, kiosks, vehicular information systems, embedded computer systems, combinations thereof, and the like.

The computer architecture 600 includes a central processing unit 602 (CPU), a system memory 604, which includes a random access memory (RAM) 606 and a read-only memory (ROM) 608, and a system bus 610 that can couple the system memory 604 to the CPU 602. A basic input/output system containing the basic routines that help to transfer information between elements within the computer architecture 600, such as during startup, can be stored in the ROM 608. The computer architecture 600 may further include a mass storage device 612. The mass storage device 612 can store an operating system 614, as well as software, data, and various program modules. In the illustrated embodiment, the mass storage device 612 stores a softbar essential network resource determination module 616. Execution of the softbar essential network resource determination module 616 by the CPU 602 can cause a computing system embodying the computer architecture 600 to provide functionality such as that described above with reference to FIGS. 1-5.

The mass storage device 612 can be connected to the CPU 602 through a mass storage controller (not illustrated) connected to the bus 610. The mass storage device 612 and its associated computer-readable media can provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, the phrase “computer storage medium” and variations thereof, does not include waves, signals, and/or other transitory and/or intangible communication media, per se.

According to various embodiments, a computing system embodying the computer architecture 600 may operate in a networked environment using logical connections to remote computers through a network such as the network 104. The computing system embodying the computer architecture 600 may connect to the network 104 through a network interface unit 618 connected to the bus 610. It should be appreciated that the network interface unit 618 may also be utilized to connect to other types of networks and remote computer systems. The computing system embodying the computer architecture 600 may also include an input/output controller 620 for receiving and processing input from a number of other devices, including a keyboard, mouse, or electronic stylus (not illustrated). Similarly, the input/output controller 620 may provide output to a video display, a printer, or other type of output device (also not illustrated).

As mentioned briefly above, a number of program modules and data files may be stored in the mass storage device 612 and RAM 606 of a computing system embodying the computer architecture 600. The program modules and data files include, but are not limited to, an operating system 614 suitable for controlling the operation of a desktop computer, laptop computer, server computer, mobile telephone, and/or other computing device or environment. The mass storage device 612, ROM 608, and RAM 606 may also store one or more program modules. In particular, the mass storage device 612, the ROM 608, and the RAM 606 may store the softbar essential network resource determination module 616 for execution by the CPU 602. The softbar essential network resource determination module 616 can include software components for implementing some, all, or none of the processes discussed in detail above with reference to FIGS. 1-5. The mass storage device 612, the ROM 608, and the RAM 606 may also store other types of program modules.

Software modules, such as the softbar essential network resource determination module 616 may be associated with the system memory 604, the mass storage device 612, or otherwise. The software modules may include software instructions that, when loaded into the CPU 602 and executed, transform a general-purpose computing system into a special-purpose computing system customized to facilitate all, or part of, the techniques for determining essential resources in a wireless network as disclosed herein. As detailed throughout this description, the program modules may provide various tools or techniques by which the a computing system embodying the computer architecture 600 may participate within the overall systems or operating environments using the components, logic flows, and/or data structures discussed herein.

The CPU 602 may be constructed from any number of transistors or other circuit elements, which may individually or collectively assume any number of states. More specifically, the CPU 602 may operate as a state machine or finite-state machine. Such a machine may be transformed to a second machine, or specific machine by loading executable instructions contained within the program modules. These computer-executable instructions may transform the CPU 602 by specifying how the CPU 602 transitions between states, thereby transforming the transistors or other circuit elements constituting the CPU 602 from a first machine to a second machine, wherein the second machine may be specifically configured to support real time event driven energy management. The states of either machine may also be transformed by receiving input from one or more user input devices associated with the input/output controller 620, the network interface unit 618, other peripherals, other interfaces, or one or more users or other actors. Either machine may also transform states, or various physical characteristics of various output devices such as printers, speakers, video displays, or otherwise.

Encoding of the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 604 when the software is encoded therein. For example, the software may transform the state of transistors, capacitors, or other discrete circuit elements constituting the system memory 604.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

Based on the foregoing, it should be appreciated that technologies for determining essential resources in a wireless network are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementation.

The subject matter described above is provided by way of illustration only and should not be construed as limiting. Various modifications and changes may be made to the subject matter described herein without following the example embodiments and applications illustrated and described, and without departing from the true spirit and scope of the present invention.

We claim:

1. A computer-implemented method for identifying a network resource (102) in a wireless networking environment (100) as essential, the method comprising computer-implemented operations for:
identifying a network resource (102) to be tested;
transitioning the network resource (102) to a softbar operation state in which use of the network resource (102) is avoided;
determining if access data (112) indicates a substantial use of the network resource (102); and
identifying the network resource (102) as essential based upon determining that the access data (112) indicates substantial use of the network resource (102).

2. The method of claim 1, wherein the softbar state further comprises an operation state in which use of the network resource (102) is allowed for an attempt to use the network resource (102) as a last resort.

3. The method of claim 1, further comprising:
determining a time period during which the network resource (102) is to be operated in the softbar state;
determining if the time period has expired; and
obtaining the access data (112) in response to determining that the time period has expired.

4. The method of claim 1, further comprising identifying the network resource (102) as non-essential by determining that access data (112) does not indicate a substantial use of the network resource (102).

5. The method of claim 1, wherein the access data (112) comprises data identifying usage of the network resource (102) during the time period.

6. The method of claim 1, further comprising taking an action to reduce the power consumption of the network resource (102), in response to identifying the network resource (102) as non-essential.

7. A computer-implemented method for identifying a network resource (102) in a wireless networking environment (100) as essential, the method comprising computer-implemented operations for:
identifying, at a central controller (108), a network resource (102) to be tested;
defining a time period during which the network resource (102) is to be tested;
generating a command (110) for transitioning the network resource (102) to a softbar operation state in which use of the network resource (102) is avoided;
determining if the time period has expired; and
in response to determining that the time period has expired,
obtaining access data (112) describing activity associated with the network resource (102) during the time period, and
identifying the network resource (102) as an essential network resource (102) in response to determining that the access data (112) indicates substantial usage of the network resource (102) during the time period.

8. The method of claim 7, further comprising generating a command (110) for transitioning the network resource (102) out of a softbar operation state, in response to determining that the time period has expired.

9. The method of claim 7, further comprising identifying the network resource (102) as a non-essential network resource (102) in response to determining that the access data (112) does not indicate substantial usage of the network resource (102) during the time period.

10. The method of claim 7, further comprising:
in response to determining that the time period has not expired, maintaining the network resource (102) in the softbar operation state.

11. The method of claim 7, wherein the network resource (102) comprises a base station (202) of the wireless networking environment (100), and determining if the access data (112) does not indicate substantial usage of the network resource (102) during the time period comprises determining that the time period has expired without an attempted handover of a communication to the base station (202).

12. The method of claim 11, further comprising receiving the access data (112) from the base station (202), the access data (112) comprising data indicating activity associated with the base station (202) during the time period.

13. The method of claim 7, further comprising receiving access data (112) comprising data indicating activity associated with the network resource (102) during the time period.

14. A central controller (108) configured to identify a network resource (102) as essential, the central controller (108) comprising a central processing unit (602) in communication with a mass storage device (612), wherein execution of computer-executable instructions stored in the mass storage device (612) cause the central processing unit (602) to:
identify a network resource (102) to be tested;
define a time period during which the network resource (102) is to be tested;
generate a command (112) for transitioning the network resource (102) to a softbar operation state in which use of the network resource (102) is avoided;
determine if the time period has expired; and
in response to determining that the time period has expired,
obtaining access data (112) describing activity associated with the network resource (102) during the time period, and
identify the network resource (102) as a non-essential network resource (102) in response to determining that the access data (112) indicates substantial usage of the network resource (102) during the time period.

15. The central controller (108) of claim 14, wherein execution of the computer-executable instructions stored in the mass storage device (612) further cause the central processing unit (602) to generate a command (110) for transitioning the network resource (102) out of a softbar operation state, in response to determining that the time period has expired.

16. The central controller (108) of claim 15, wherein execution of the computer-executable instructions stored in the mass storage device (612) cause the central processing unit (602) to identify the network resource (102) from a plurality of network resources (102), and the plurality of network resources (102) provide services to a geographic area.

17. The central controller (108) of claim 16, wherein the plurality of network resources (102) comprises a plurality of base stations (202), each of the plurality of base stations (202) having a respective coverage area (204), and at least two of the coverage areas (204) of the base stations (202) overlap, at least partially.

18. The central controller (108) of claim 17, wherein the usage of the network resource (102) comprises a handover of a call from one of the plurality of base stations (202) to a second of the plurality of base stations (202), the call being associated with a mobile station (106) located within at least one of the plurality of coverage areas (204).

19. The central controller (108) of claim 17, wherein the usage of the network resource (102) comprises access of the base station (202) as a last resort during the time period.

20. A central controller (108) configured to identify a base station (202) as essential, the central controller (108) comprising a central processing unit (602) in communication with a mass storage device (612), wherein execution of computer-executable instructions stored in the mass storage device (612) cause the central processing unit (602) to:
identify a base station (202) to be tested;
transition the base station (202) to a softbar operation state in which use of the base station (202) is avoided;
detect an attempt to use the base station (202) during operation in the softbar operation state;
determine if the attempt to use the base station (202) comprises an attempt to use the base station (202) as a last resort;
identify the base station (202) as essential in response to determining that the attempt to use the base station (202) comprises an attempt to use the base station (202) as a last resort;
identify the base station (202) as non-essential in response to determining that the attempt to use the base station (202) does not comprise an attempt to use the base station (202) as a last resort; and
reduce power consumption associated with the base station (202), in response to identifying the base station (202) as non-essential.
